(19) United States
(12) Patent Application Publication
(10) Pub. No.: US 2026/0077429 A1
(43) Pub. Date: Mar. 19, 2026

(54) LASER BEAM DIMMING DEVICE

(71) Applicant: Tamron Co., Ltd., Saitama (JP)

(72) Inventors: Kazunori KOMORI, Saitama (JP); Takashi SAKAMOTO, Saitama (JP)

(73) Assignee: Tamron Co., Ltd., Saitama (JP)

(21) Appl. No.: 19/308,123

(22) Filed: Aug. 22, 2025

(30) Foreign Application Priority Data
Sep. 13, 2024 (JP) 2024-159077

(51) Int. Cl. B23K 26/06; B23K 26/067

(52) U.S. Cl. CPC B23K 26/0648; B23K 26/067

(57) ABSTRACT

To achieve this object, there is provided a laser beam dimming device including a beam splitter in which reflected light is used as observation light, wherein the beam splitter reflects 10% or less of incident light, the beam splitter is disposed such that an incident angle of the incident light at a position of an optical axis is 45° with an X axis as a rotation axis when arbitrary orthogonal coordinate axes whose origin on a plane perpendicular to the optical axis is an optical axis are an X axis and a Y axis, and a cross-sectional shape of the beam splitter on a plane determined by the incident light and the reflected light of the beam splitter is a wedge shape in which an incident light side of the beam splitter is thin and a reflected light side of the beam splitter is thick.

### CROSS-REFERENCE TO RELATED APPLICATIONS

This application is based on and claims the benefit of priority from Japanese Patent Application No. 2024-159077, filed on Sep. 13, 2024, the entire contents of which are incorporated herein by reference.

### BACKGROUND OF THE INVENTION

### Technical Field

The present invention relates to a laser beam dimming device for dimming a laser beam provided in a laser beam profiler used when profiling a laser beam irradiated from a laser beam irradiation optical system for forming a spot on a workpiece and irradiating the workpiece with the laser beam to perform laser processing.

### Related Art

In recent years, laser beams have been widely used for processing various products. The laser beam is focused at one point to be irradiated to a workpiece, thereby rapidly increasing a surface temperature of the workpiece and melting or evaporating an irradiated surface of the workpiece. A laser processing device using such a laser beam is a device that performs processing such as cutting, drilling, or welding on the workpiece in this way. Since the laser beam is focused at one point, precise and fine processing can be performed at a pinpoint. By using a higher-energy laser beam, it is possible to shorten a processing time and it is also possible to perform processing on a high-hardness workpiece that is difficult to be processed with a blade.

Here, the laser processing device includes a laser beam irradiation optical system. Conventionally, the laser beam irradiation optical system has had the function of focusing the laser beam onto one spot and irradiating the laser beam so that the image shape of the laser beam on the spot is circular and the energy intensity distribution is Gaussian or top hat shaped. However, in laser processing employing this conventional spot image shape, when cutting, welding, or drilling a workpiece, the workpiece melted by the laser beam remains on the cut surface or in the hole, resulting in a deterioration in processing quality. In recent years, there has been proposed laser processing in which the image shape of the laser beam at the spot is made annular to appropriately scatter the molten workpiece so that no part of the workpiece remains on the cut surface or in the hole.

Before laser processing is performed, a laser beam profiler is used to confirm that an image shape of a laser beam and an energy intensity distribution of the image shape at the spot have desired specifications. As laser beam dimming means in this laser beam profiler, the following method has been known: a method in which a laser beam is dimmed through a filter and is observed by an image sensor such as a CCD or CMOS, a method in which a transmitted light intensity is measured while a part of the laser beam is shielded with a pinhole, a slit, or a knife edge, and is obtained by a calculation from a correlation of the transmitted light intensity with a light shielding position, a method in which an intensity distribution is measured by secondarily scanning a rod with a small mirror at a tip or a light guide rod with a small hole at a tip in a laser beam, a method in which a plate for scattering the laser beam is irradiated with a laser beam and an image of scattered light is captured by a camera from behind, or the like.

However, in the above-described method, there is problem that the filter is deformed by heat of the laser beam, the image shape of the laser beam is distorted in the pinhole, the slit, or the knife edge, a minute image shape is difficult to be measured with the small mirror, or blurring occurs in the image when the scattered light is used. Therefore, there has also been proposed a method of measuring the image shape of the laser beam and the energy intensity distribution in the image shape by dividing the laser beam into transmitted light and reflected light using a beam splitter to dim the beam and observing the transmitted light or the reflected light which are dimmed.

When light is dimmed using such a beam splitter, stray light may become a problem. For example, when the reflected light of the parallel flat plate beam splitter is used as the dimming light, there are not only a front surface reflection optical path in which light is reflected on the front surface of the beam splitter, but also a back surface reflection optical path in which light is transmitted through the front surface of the beam splitter, reflected by the back surface of the beam splitter, and transmitted through the front surface of the beam splitter. In addition, there is a back surface reflection optical path in which light is similarly repeatedly reflected inside the beam splitter and transmitted through the front surface to be emitted. The light due to the back surface reflection optical path is stray light. Since the stray light due to the back surface reflection optical path is parallel light of the reflected light due to the front surface reflection optical path, when the stray light enters an observation device such as an image sensor, there arises a problem that an image of a laser beam cannot be correctly observed.

Therefore, J P 2022-537450 W proposes a nano-texture attenuator that attenuates a laser beam using reflected light of a beam splitter having a wedge-shaped cross section instead of a parallel flat plate. Even in the wedge-shaped beam splitter, the above-described back surface reflection optical path exists, but since the cross section of the beam splitter is wedge-shaped, stray light due to the back surface reflection optical path of the wedge-shaped beam splitter becomes non-parallel light with respect to the reflected light due to the front surface reflection optical path, and it can be expected that stray light is suppressed from being incident to the image sensor.

Since a laser processing device focuses a laser beam on one point of a spot to rapidly increase the surface temperature of a workpiece and perform processing, observation light observed by a laser beam profiler is generally focused light. In such a case, observation light having a large numerical aperture (NA) is observed. However, when observing observation light having a large numerical aperture, the inventor has found that there is a problem that a countermeasure against stray light cannot be sufficiently exerted in the nano texture attenuator employing the wedge-shaped beam splitter disclosed in JP 2022-537450 W.

The present invention has been made in view of such circumstances. An object of the present invention is to provide a laser beam dimming device capable of dimming a laser beam to a predetermined intensity and separating observation light and stray light even when observation light having a large numerical aperture is observed.

### SUMMARY OF THE INVENTION

In order to solve the above-described problems, as a result of intensive studies, the following laser beam dimming device has been conceived.

A laser beam dimming device according to the present invention is a laser beam dimming device for dimming a laser beam provided in a laser beam profiler, including: a beam splitter 1 in which reflected light is used as observation light, wherein the beam splitter 1 reflects 10% or less of incident light, wherein the beam splitter 1 is disposed such that an incident angle of incident light at a position of an optical axis is 45° with an X axis as a rotation axis when arbitrary orthogonal coordinate axes whose origin on a plane perpendicular to the optical axis is on the optical axis are an X axis and a Y axis, and wherein a cross-sectional shape of the beam splitter 1 on a plane determined by the incident light and the reflected light of the beam splitter 1 is a wedge shape in which an incident light side of the beam splitter 1 is thin and a reflected light side of the beam splitter 1 is thick.

A laser beam profiler according to the present invention employs a laser beam profiler including the above-described laser beam dimming device and an observation device that observes observation light dimmed by the laser beam dimming device.

The laser beam dimming device according to the present invention can dim the laser beam to a predetermined intensity and separate the observation light and the stray light even when observing observation light having a large numerical aperture.

### BRIEF DESCRIPTION OF THE DRAWINGS

FIGS. 1A and 1B are a cross-sectional view of a beam splitter 1 according to a first embodiment and a schematic view showing trajectories of incident light and reflected light;

FIG. 2 is a schematic view showing a relationship between reflected light and stray light of the first embodiment;

FIGS. 3A and 3B are a cross-sectional view of a beam splitter 1 and a beam splitter 2 according to a second embodiment and a schematic view showing trajectories of incident light and reflected light;

FIGS. 4A and 4B are a cross-sectional view of a beam splitter 1 according to a third embodiment, a view of a beam splitter 2′ as viewed from an incident direction of a laser beam, and a schematic view showing trajectories of incident light and reflected light to the beam splitter 1 and the beam splitter 2′, respectively;

FIGS. 5A and 5B is a cross-sectional view of the beam splitter 1 according to the third embodiment, a view of the beam splitter 2′ as viewed from an incident direction of a laser beam, and a schematic view showing trajectories of incident light and reflected light to the beam splitter 1 and the beam splitter 2′, respectively;

FIGS. 6A and 6B are a schematic view showing a portion of the beam splitter 2′ of FIGS. 4A and 4B in a direction in which a Y axis is perpendicular to the drawing;

FIGS. 7A and 7B are a schematic view showing a portion of the beam splitter 2′ of FIGS. 5A and 5B in a direction in which a Y axis is perpendicular to the drawing;

FIGS. 8A and 8B show simulation results of reflected light and stray light in Example 1;

FIG. 9 shows simulation results of reflected light and stray light in Example 2;

FIG. 10 shows simulation results of reflected light and stray light in Example 3;

FIG. 11 shows simulation results of reflected light and stray light in Example 4;

FIG. 12 shows simulation results of reflected light and stray light in Example 5;

FIG. 13 shows simulation results of reflected light and stray light in Example 6;

FIGS. 14A and 14B show simulation results of reflected light and stray light in Comparative Example 1;

FIG. 15 shows simulation results of reflected light and stray light in Comparative Example 2;

FIG. 16 shows simulation results of reflected light and stray light in Comparative Example 3;

FIG. 17 is an overall configuration diagram in which the laser beam dimming device according to the second embodiment is attached to an optical system of a laser processing device; and

FIG. 18 is an overall configuration diagram in which the laser beam dimming device according to the third embodiment is attached to an optical system of a laser processing device.

### DESCRIPTION OF THE EMBODIMENTS

Hereinafter, embodiments of a laser beam dimming device and a laser beam profiler including the laser beam dimming device according to the present invention will be described. Furthermore, the following description merely shows one embodiment, and should not be construed as being limited to the following description.

### 1. Embodiments of Laser Beam Dimming Device

A laser beam dimming device according to the present invention is a laser beam dimming device for dimming a laser beam provided in a laser beam profiler. A laser beam profiler is used to confirm, before laser processing, that the image shape of the laser beam at the spot and the energy intensity distribution in the image shape meet desired specifications. Then, the laser beam dimming device is a laser beam dimming (attenuating) device used to prevent the high energy of the laser beam from damaging observation devices such as image sensors provided in the laser beam profiler.

The laser beam profiler is attached between the spot and a laser beam irradiation optical system, which irradiates the laser beam so as to form the desired image shape of the laser beam at the spot and the desired energy intensity distribution of the laser beam and focus the laser beam on the spot, and observes the image shape of the laser beam at the spot and the energy intensity distribution of the laser beam. Then, the laser beam profiler can be detached from the laser beam irradiation optical system after the image shape of the laser beam and the energy intensity distribution of the laser beam at the spot are measured and the image shape of the laser beam and the energy intensity distribution of the laser beam at the spot are adjusted and measured again when necessary. Thereafter, the workpiece can be placed at the spot position and laser processing can be performed.

The laser beam that is incident on the laser beam dimming device according to the present invention from a laser oscillator via an optical fiber can be any laser beam that can be used for laser processing. Specifically, a near-infrared laser beam having an oscillation wavelength of about 920 nm or more and 1090 nm or less, which is represented by a YAG laser (wavelength of 1064 nm), a fiber laser (wavelength of 1070 nm), a disk laser (wavelength of 1030 nm), and a semiconductor laser (wavelength of 935 nm, 940 nm, 980 nm, 940 to 980 nm, or 940 to 1025 nm), is preferable. The laser beam may be a laser beam in a blue, green, or ultraviolet region as long as the laser beam can be used for laser processing.

### First Embodiment of Laser Beam Dimming Device

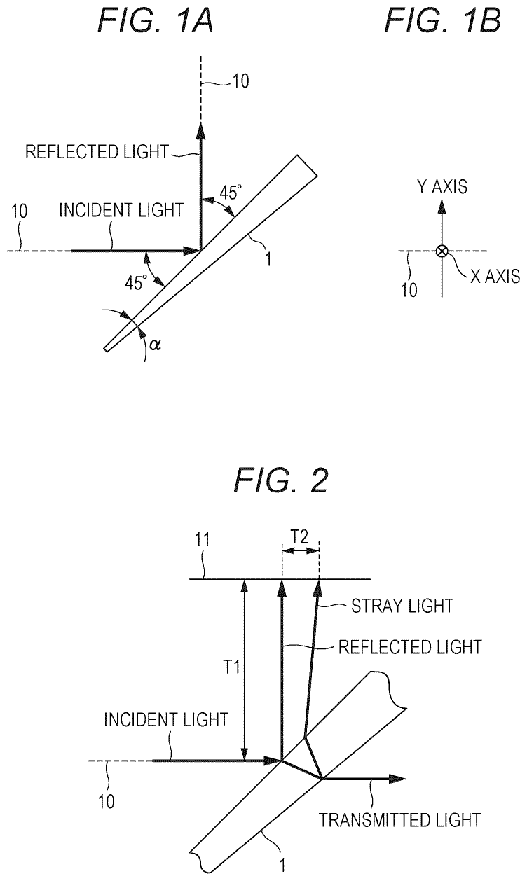

FIGS. 1A and 1B show a cross-sectional view of a beam splitter 1 in a laser beam dimming device according to the present invention and a schematic view showing trajectories of incident light and reflected light to the beam splitter 1. The cross section of the beam splitter 1 shows a portion cut out in a plane determined by incident light and reflected light of the beam splitter 1. Only the incident light and the reflected light on the portion of the optical axis 10 are shown. The incident light is actually focused light of a laser beam, but is not shown. In the specification of the present invention, when simply expressed as incident light and reflected light, the incident light to the front surface of the beam splitter 1 and the reflected light reflected by the front surface are indicated. Similarly, in other beam splitters, the expression means the same.

In FIGS. 1A and 1B, a laser beam dimming device according to the present invention includes the beam splitter 1 in which reflected light is used as observation light, and the beam splitter 1 is disposed such that an incident angle of incident light at a position of the optical axis 10 is 45° with the X axis as a rotation axis when arbitrary orthogonal coordinate axes whose origin in a plane perpendicular to the optical axis 10 is the optical axis 10 are an X axis and a Y axis. The cross-sectional shape of the beam splitter 1 on the plane determined by the incident light and the reflected light of the beam splitter 1 is a wedge shape in which the incident light side of the beam splitter 1 is thin and the reflected light side of the beam splitter 1 is thick. Furthermore, as is clear from FIGS. 1A and 1B, the “incident light side of the beam splitter 1” indicates a side on which incident light forms an incident angle of 45° in the cross-sectional shape of the beam splitter 1, and the “reflected light side of the beam splitter 1” indicates a side on which reflected light forms an emission angle of 45° in the cross-sectional shape of the beam splitter 1. In the specification of the present invention, the expression means the same in other beam splitters. FIG. 1B shows a relationship between an X axis and a Y axis in FIGS. 1A and 1B, and the X axis means a direction perpendicular to the plane of FIGS. 1A and 1B.

The beam splitter 1 has a reflectance characteristic of reflecting 10% or less of incident light. This is because the reflected light is used as dimmed (attenuated) observation light. Furthermore, “reflecting 10% or less of incident light” means reflecting 10% or less of the energy of the incident light, and the reflection in the provision is due to reflection on the surface of the beam splitter 1 and does not include a stray light component. Hereinafter, the same applies to other beam splitters.

Then, the angle α of the wedge shape of the beam splitter 1 is preferably 0.5° or more. This is because, in the configuration of the laser beam dimming device according to the present invention shown in FIGS. 1A and 1B, the observation light and the stray light can be separated even when the observation light having a large numerical aperture is observed. For this reason, the angle α of the wedge shape of the beam splitter 1 is more preferably 1° or more.

Although FIGS. 1A and 1B show only the laser beam at the position of the optical axis, the laser beam actually incident is focused light. In this case, the incident angle of the laser beam on the beam splitter 1 continuously changes from 45° of the position of the optical axis with increasing distance from the position of the optical axis. Therefore, as the beam splitter 1 in the first embodiment, it is preferable to employ a beam splitter in which the reflectance in the range of the incident angle of the beam splitter 1 is substantially constant (for example, the variation of the reflectance with respect to the average value of the reflectances in the range of the incident angle is within 5%). This is because the energy intensity distribution can be accurately measured using the reflected light even in the case of the condensed light in which the incident angle continuously changes in the incident light to the beam splitter 1. On the other hand, in the case of using the beam splitter in which the reflectance continuously changes in the range of the incident angle, the energy intensity distribution of the reflected light has the influence of different reflectances added according to the incident position on the beam splitter 1, and the energy intensity distribution cannot be accurately measured.

FIG. 2 is a schematic view showing a relationship between reflected light and stray light. The laser beam dimming device according to the first embodiment adopts the wedge shape in which the incident light side of the beam splitter 1 is thin and the reflected light side of the beam splitter 1 is thick in the cross-sectional shape of the beam splitter 1 on the plane determined by the incident light and the reflected light of the beam splitter 1, so that the distance from the optical axis of the stray light due to the incident light at the position of the optical axis of the beam splitter 1 can be set to T2 (mm) or more on a surface 11 perpendicular to the optical axis at a place separated by the distance T1=(mm) along the optical axis from the position of the optical axis of the surface of the beam splitter 1 where the reflected light is used as the observation light to the reflected light side. For example, when the angle α of the wedge shape of the beam splitter 1 is 3°, T1=40 mm and T2=10 mm or more can be set. As a result, it is possible to prevent stray light from being incident to an observation device such as an image sensor. Furthermore, stray light in FIG. 2 represents a laser beam that is transmitted through the front surface of the beam splitter 1, is reflected by the back surface of the beam splitter 1, and is transmitted through the front surface of the beam splitter 1, and stray light that is repeatedly reflected inside the beam splitter 1 and is transmitted through the front surface to be emitted is not shown.

Furthermore, the laser beam dimming device according to the present invention uses reflected light of a beam splitter as observation light. Although it is conceivable to use the transmitted light of the beam splitter as observation light, when the incident light is condensed light, astigmatism occurs in the transmitted light, and the image shape is distorted. Although it is possible to correct distortion of the image shape due to astigmatism by using three or more beam splitters, it is not preferable to use transmitted light as observation light for the reason that the number of optical elements used for the laser beam dimming device increases as compared with the case of using reflected light, the beam splitter is difficult to be arranged in an optical system having a short focal length, and the like.

### Second Embodiment of Laser Beam Dimming Device

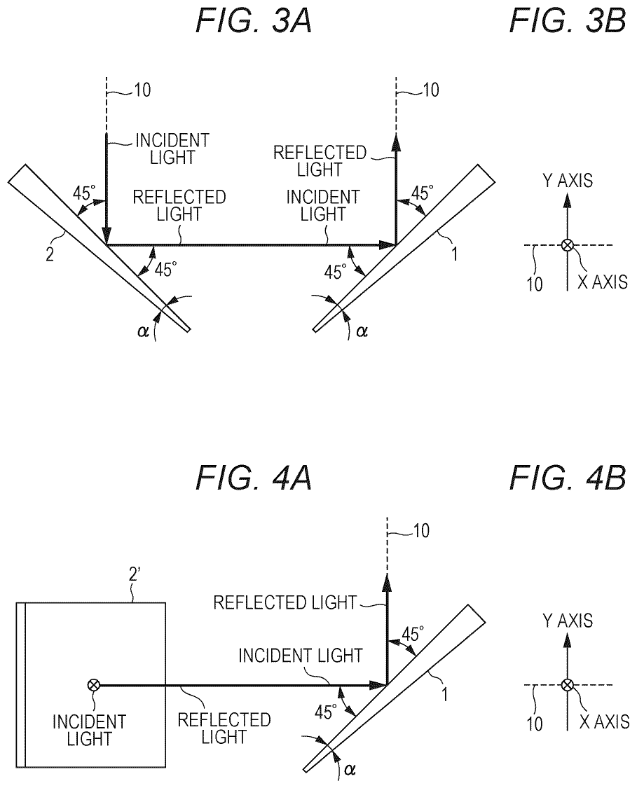

FIGS. 3A and 3B show, as a second embodiment, cross-sectional views of the beam splitter 1 and the beam splitter 2 in the laser beam dimming device according to the present invention, and schematic views showing trajectories of incident light and reflected light to the beam splitter and the beam splitter, respectively. The cross section of the beam splitter 2 shows a portion cut out in a plane determined by incident light and reflected light of the beam splitter 2. Only the incident light and the reflected light on the portion of the optical axis 10 are shown. Although the laser beam is actually condensed, illustration is omitted. The beam splitter 1 is the same as that of the first embodiment.

In FIGS. 3A and 3B, the second embodiment of the laser beam dimming device according to the present invention includes the beam splitter 2 disposed such that an incident angle of incident light at a position of the optical axis 10 is 45° with an X′ axis parallel to the X axis and passing through the optical axis 10 as a rotation axis, in addition to the beam splitter 1 in which reflected light is used as observation light. The beam splitter 2 is disposed such that reflected light of the beam splitter 2 enters the beam splitter 1. At this time, the direction of the reflection surface of the beam splitter 2 is a direction in which a plane including the reflection surface of the beam splitter 1 and a plane including the reflection surface of the beam splitter 2 are orthogonal to each other. The cross-sectional shape of the beam splitter 2 on the plane determined by the incident light and the reflected light of the beam splitter 2 is a wedge shape in which the incident light side of the beam splitter 2 is thick and the reflected light side of the beam splitter 2 is thin. FIG. 3B shows a relationship between the X axis and the Y axis in FIGS. 3A and 3B, and the X axis means a direction perpendicular to the plane in FIGS. 3A and 3B.

The beam splitter 2 has a reflectance characteristic of reflecting 10% or less of incident light. This is because the reflected light is used as dimmed (attenuated) observation light.

The angle α of the wedge shape of the beam splitter 2 is preferably 0.5° or more. This is because, in the configuration of the laser beam dimming device according to the present invention shown in FIGS. 3A and 3B, the observation light and the stray light can be separated even when the observation light having a large numerical aperture is observed.

Although FIGS. 3A and 3B show only the laser beam at the position of the optical axis, the laser beam actually incident is the focused light. In this case, the incident angle of the laser beam on the beam splitter continuously changes from 45° of the position of the optical axis with increasing distance from the position of the optical axis. In the first embodiment, it is preferable to employ a beam splitter in which the reflectance in the range of the incident angle of the beam splitter 1 is substantially constant. However, in the second embodiment, it is not always necessary to employ a beam splitter in which the reflectance in the range of the incident angle is substantially constant, and a beam splitter in which the reflectance continuously changes in the range of the incident angle may be employed as the beam splitter 1 and the beam splitter 2.

The above will be described. In the second embodiment shown in FIGS. 3A and 3B, reflected light reflected by the beam splitter 2 is incident on the beam splitter 1. In the case of this configuration, even if the condensed light is incident on the beam splitter 2, the laser beam incident on the beam splitter 2 at an angle smaller than 45° is incident on the beam splitter 1 at an angle larger than 45°, and the laser beam incident on the beam splitter 2 at an angle larger than 45° is incident on the beam splitter 1 at an angle smaller than 45°. In this case, the reflected light reflected by the beam splitter 2 and reflected by the beam splitter 1 can cancel the change in the reflectance due to the incident angle even if the reflectance of the surface of the beam splitter has a characteristic of continuously changing according to the change in the incident angle. Therefore, the reflected light of the beam splitter 1 of the second embodiment can accurately measure the energy intensity distribution. In this case, it is preferable to adopt the same incident angle characteristic of the reflectances of the beam splitter 1 and the beam splitter 2.

Furthermore, in the arrangement in which the plane including the reflection surface of the beam splitter 1 and the plane including the reflection surface of the beam splitter 2 are parallel in the direction of the reflection surface of the beam splitter 2, since the laser beam incident on the beam splitter 2 at an angle smaller than 45° is incident on the beam splitter 1 at an angle smaller than 45° and the laser beam incident on the beam splitter 2 at an angle larger than 45° is incident on the beam splitter 1 at an angle larger than 45°, it is not possible to offset the change in reflectance due to the incident angle.

FIG. 17 shows an overall configuration diagram in which the laser beam dimming device according to the second embodiment is attached to the optical system of the laser processing device. FIG. 17 shows a state in which a laser beam radially irradiated from an emission end of a fiber laser (not shown in the upper part of the drawing) is incident on the beam splitter 2 via a collimating lens, a condenser lens, and a protective glass, and the laser beam reflected by the front surface of the beam splitter 2 is reflected by the front surface of the beam splitter 1 and condensed. Furthermore, in FIG. 17, the beam splitter 1 and the beam splitter 2 display only the reflection surfaces. In addition, stray light is not shown.

In the laser beam dimming device according to the second embodiment, the wedge shape in which the incident light side of the beam splitter 1 is thin and the reflected light side of the beam splitter 1 is thick is adopted in the cross-sectional shape of the beam splitter 1 in the plane determined by the incident light and the reflected light of the beam splitter 1, and the wedge shape in which the incident light side of the beam splitter 2 is thick and the reflected light side of the beam splitter 2 is thin is adopted in the cross-sectional shape of the beam splitter 2 in the plane determined by the incident light and the reflected light of the beam splitter 2, so that the distance from the optical axis of stray light closest to the optical axis among all stray light generated by the beam splitter 1 and the beam splitter 2 can be T2 (mm) or more on a surface 11 perpendicular to the optical axis at a distance T1 (mm) along the optical axis from the position of the optical axis on the front surface of the beam splitter 1 to the reflected light side. For example, when the angle α of the wedge shape of the beam splitter 1 and the beam splitter 2 is 1°, T1=90 mm and T2=3.5 mm or more can be set. As a result, it is possible to prevent stray light from being incident to an observation device such as an image sensor. The stray light in the second embodiment includes stray light generated by the beam splitter 2. Specifically, examples of the stray light include front-surface/back-surface reflection type stray light reflected by the front surface of the beam splitter 2, transmitted through the front surface of beam splitter 1, reflected by the back surface, and transmitted through the front surface to be emitted, back-surface/front-surface reflection type stray light transmitted through the front surface of the beam splitter 2, reflected by the back surface, transmitted through the front surface, and reflected by the front surface of the beam splitter 1 to be emitted, back-surface/back-surface reflection type stray light transmitted through the front surface of the beam splitter 2, reflected by the back surface, transmitted through the front surface, transmitted through the front surface of the beam splitter 1, reflected by the back surface, and transmitted through the front surface to be emitted, and the like.

Since the second embodiment uses two beam splitters as described above, it is possible to greatly dim (attenuate) the laser beam as compared with the first embodiment using one beam splitter. In this case, it is possible to cope with a laser beam having a large energy intensity.

Furthermore, when a wedge-shaped configuration in which the incident light side of the beam splitter 2 is thin and the reflected light side of the beam splitter 2 is thick is used in the cross-sectional shape of the beam splitter 2 on the plane determined by the incident light and the reflected light of the beam splitter 2, it is not preferable since it is not possible to sufficiently suppress the stray light generated in the beam splitter 2 from being incident to the observation device such as the image sensor.

### Third Embodiment of Laser Beam Dimming Device

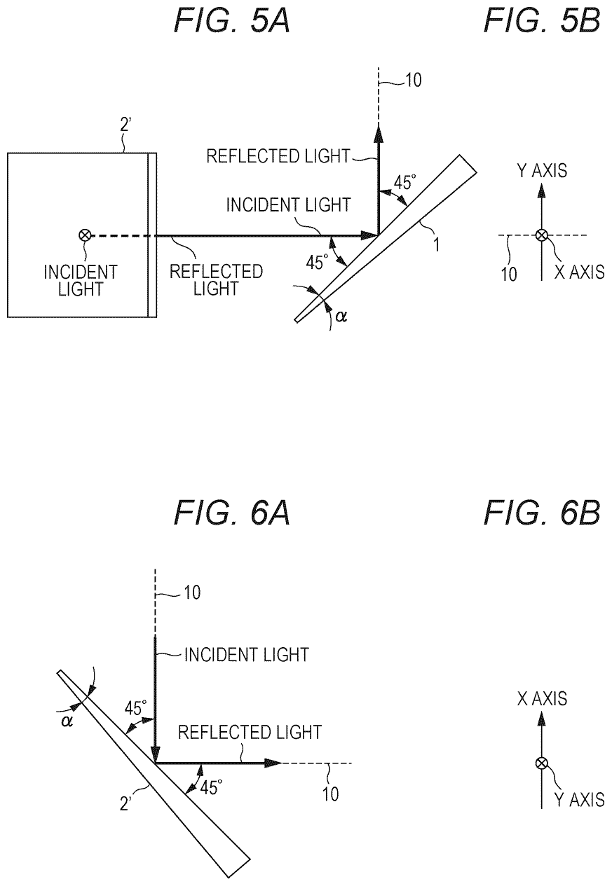

As a third embodiment, FIGS. 4A, 4B, 5A and 5B show a cross-sectional view of the beam splitter 1 in the laser beam dimming device according to the present invention, a diagram of a beam splitter 2′ as viewed from the incident direction of the laser beam, and a schematic view showing trajectories of incident light and reflected light to the beam splitter 1 and the beam splitter 2′, respectively. The light incident on the beam splitter 2′ in FIGS. 4A and 4B is incident in a direction perpendicular to the drawing from the front to the back of the drawing, and the light incident on the beam splitter 2′ in FIGS. 5A and 5B is incident in a direction perpendicular to the drawing from the back to the front of the drawing. Only the incident light and the reflected light on the portion of the optical axis 10 are shown. Although the laser beam is actually condensed, illustration is omitted. The beam splitter 1 is the same as that of the first embodiment.

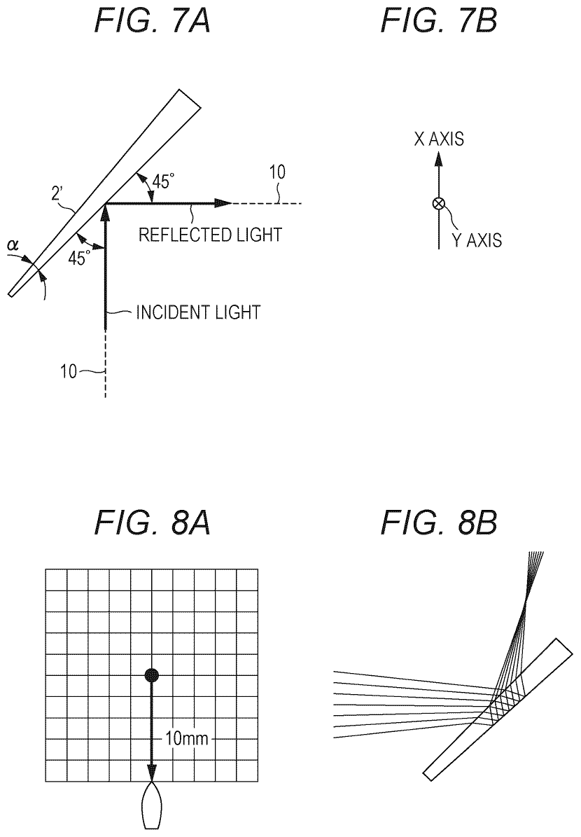

In FIGS. 4A, 4B, 5A and 5B, the third embodiment of the laser beam dimming device according to the present invention includes the beam splitter 2′ disposed such that an incident angle of incident light at a position of the optical axis 10 is 45° with a Y′ axis parallel to the Y axis and passing through the optical axis 10 as a rotation axis, in addition to the beam splitter 1 in which reflected light is used as observation light. This beam splitter 2′ is disposed such that reflected light of the beam splitter 2′ is incident on the beam splitter 1. FIGS. 6A, 6B, 7A and 7B show schematic views of the portion of the beam splitter 2′ of FIGS. 4A, 4B, 5A and 5B in a direction in which the Y-axis is perpendicular to the drawings. As shown in FIGS. 6A, 6B, 7A and 7B, the cross-sectional shape of the beam splitter 2′ in the plane determined by the incident light and the reflected light of the beam splitter 2′ is a wedge shape in which the incident light side of the beam splitter 2′ is thin and the reflected light side of the beam splitter 2′ is thick. FIGS. 4B and 5B show a relationship between the X axis and the Y axis in FIGS. 4A, 4B, 5A and 5B, and the X axis means the direction perpendicular to the surfaces in FIGS. 4A, 4B, 5A and 5B. FIGS. 6B and 7B show a relationship between the X axis and the Y axis in FIGS. 6A, 6B, 7A and 7B, and the Y axis means a direction perpendicular to the surfaces in FIGS. 6A, 6B, 7A and 7B.

The beam splitter 2′ has a reflectance characteristic of reflecting 10% or less of incident light. This is because the reflected light is used as dimmed (attenuated) observation light.

The angle α of the wedge shape of the beam splitter 2′ is preferably 0.5° or more. This is because, in the configuration of the laser beam dimming device according to the present invention shown in FIGS. 4A, 4B, 5A and 5B, the observation light and the stray light can be separated even when the observation light having a large numerical aperture is observed.

Although FIGS. 4A, 4B, 5A and 5B show only the laser beam at the position of the optical axis, the actually incident laser beam is focused light. In this case, the incident angle of the laser beam on the beam splitter continuously changes from 45° of the position of the optical axis with increasing distance from the position of the optical axis. In the third embodiment, it is preferable to employ, as the beam splitter 1 and the beam splitter 2′, a beam splitter in which the reflectance in the range of the incident angle is substantially constant as described in the first embodiment. This is because the energy intensity distribution can be accurately measured using the reflected light even in the case of the condensed light in which the incident angle continuously changes in the incident light to the beam splitter 1. On the other hand, in the case of using the beam splitter in which the reflectance continuously changes in the range of the incident angle, the energy intensity distribution of the reflected light is obtained by adding the influence of different reflectances depending on the incident position on the beam splitter 1 or the beam splitter 2′, and the energy intensity distribution cannot be accurately measured.

FIG. 18 shows an overall configuration diagram in which the laser beam dimming device according to the third embodiment is attached to the optical system of the laser processing device. FIG. 18 shows a state in which a laser beam radially irradiated from an emission end of a fiber laser (not shown in the upper part of the drawing) is incident on the beam splitter 2′ via a collimating lens, a condenser lens, and a protective glass, and the laser beam reflected by the front surface of the beam splitter 2′ is reflected and condensed on the front surface of the beam splitter 1. Furthermore, in FIG. 18, the beam splitter 1 and the beam splitter 2′ display only the reflection surfaces. In addition, stray light is not shown.

The laser beam dimming device according to the third embodiment employs a wedge shape in which the incident light side of the beam splitter 1 is thin and the reflected light side of the beam splitter 1 is thick in the cross-sectional shape of the beam splitter 1 on the plane determined by the incident light and the reflected light of the beam splitter 1, and employs a wedge shape in which the incident light side of the beam splitter 2′ is thin and the reflected light side of the beam splitter 2 is thick in the cross-sectional shape of the beam splitter 2′ on the plane determined by the incident light and the reflected light of the beam splitter 2′. In this manner, in the surface 11 perpendicular to the optical axis at a place away from the position of the optical axis on the front surface of the beam splitter 1 by a distance T1 (mm) along the optical axis on the reflected light side, the distance from the optical axis of stray light closest to the optical axis among all stray light generated by the beam splitter 1 and the beam splitter 2′ can be T2 (mm) or more. For example, when the angle α of the wedge shape of the beam splitter 1 and the beam splitter 2′ is 0.5°, T1=40 mm and T2=4.5 mm or more can be set. As a result, it is possible to prevent stray light from being incident to an observation device such as an image sensor. Furthermore, the stray light in the third embodiment includes stray light generated by the beam splitter 2′. Specifically, examples of the stray light include front-surface/back-surface reflection type stray light reflected by the front surface of the beam splitter 2′, transmitted through the front surface of the beam splitter 1, reflected by the back surface, and transmitted through the front surface to be emitted, back-surface/front-surface reflection type stray light transmitted through the front surface of the beam splitter 2′, reflected by the back surface, transmitted through the front surface, and reflected by the front surface of the beam splitter 1 to be emitted, back-surface/back-surface reflection type stray light transmitted through the front surface of the beam splitter 2′, reflected by the back surface, transmitted through the front surface, transmitted through the front surface of the beam splitter 1, reflected by the back surface, and transmitted through the front surface to be emitted, and the like.

Since the third embodiment uses two beam splitters as described above, it is possible to greatly dim (attenuate) the laser beam as compared with the first embodiment using one beam splitter. In this case, it is possible to cope with a laser beam having a large energy intensity. In addition, in the second embodiment, since the emission direction of the observation light returns to the incident light side to the laser beam dimming device according to the second embodiment, there is a restriction on the arrangement of the laser beam dimming device and the observation device according to the second embodiment. However, in the third embodiment, since the emission direction of the observation light is a direction different from the incident light side to the laser beam dimming device according to the third embodiment, there is a high degree of freedom in the arrangement of the laser beam dimming device and the observation device according to the third embodiment.

Furthermore, when a wedge-shaped configuration in which the incident light side of the beam splitter 2′ is thick and the reflected light side of the beam splitter 2′ is thin is used in the cross-sectional shape of the beam splitter 2′ on the plane determined by the incident light and the reflected light of the beam splitter 2′, it is not preferable since it is not possible to sufficiently suppress the stray light generated in the beam splitter 2′ from being incident to the observation device such as the image sensor.

### [Beam Splitter]

As the optical material of the beam splitter 1, the beam splitter 2, and the beam splitter 2′, quartz having a refractive index of 1.449 at a wavelength of 1070 nm is preferable. This is because quartz has a high transmittance at a wavelength of 1070 nm and a small linear expansion coefficient, so that quartz is hardly damaged even when a laser beam is incident.

### 2. Embodiments of Laser Beam Profiler

A laser beam profiler according to the present invention includes the above-described laser beam dimming device and an observation device that observes observation light dimmed by the laser beam dimming device. Since the laser beam profiler according to the present invention includes the above-described laser beam dimming device, even when observation light having a large numerical aperture is observed, the laser beam can be dimmed to a predetermined intensity and the observation light and the stray light can be separated. Accordingly, the image shape and energy intensity distribution of the laser beam at the spot can be accurately observed and measured.

### [Observation Device]

The observation device is not particularly limited as long as it can observe the irradiation position or image shape of the laser beam at the spot and the energy intensity distribution of the laser beam, and any observation device can be used, such as an image sensor such as a CCD or CMOS.

The embodiment of the present invention described above is one aspect of the present invention, and can be modified as appropriate without departing from the spirit of the present invention. In addition, the dimming device of the present invention will be more specifically described below using the following Examples, but the present invention is not limited to the following Examples.

### Example 1

Example 1 is a configuration of the first embodiment of the laser beam dimming device. The beam splitter 1 having a refractive index of 1.449 at a wavelength of 1070 nm, a wedge-shaped angle α of 3°, and a thickness at the position of the optical axis of 7 mm was used. Then, reflected light and stray light when condensed light of a laser beam having a wavelength of 1070 nm in which a spot has a dotted shape and an energy intensity distribution is uniform is incident on the beam splitter 1 were simulated using optical design software Optic Studio (manufactured by Zemax Japan Ltd.). Furthermore, the stray light in the simulation is only for a laser beam that is transmitted through the front surface of the beam splitter 1, reflected by the back surface of the beam splitter 1, and transmitted through the front surface of the beam splitter 1, and a laser beam that is repeatedly reflected inside the beam splitter 1 and transmitted through the front surface to be emitted is omitted. This is because the position of the image on the imaging plane of the laser beam repeatedly reflected inside the beam splitter 1 and transmitted through the front surface to be emitted is farther than the position of the laser beam reflected once on the back surface of the beam splitter 1 and transmitted through the front surface.

A distance T1 from the position of the optical axis of the beam splitter 1 to the imaging plane on the reflected light side is set to 40 mm, and an image of reflected light and stray light on a plane perpendicular to the optical axis on the imaging plane is shown in FIG. 8A. The black spot image at the center of FIG. 8A is reflected light. An image of vertically distorted stray light is shown at a position T2=10 mm away from the black spot image. That is, it was confirmed that stray light can be separated from reflected light at a distance of T2=10 mm in the imaging plane. Furthermore, FIG. 8B shows trajectories of incident light and stray light in the beam splitter 1 in the simulation of Example 1, and does not show a trajectory of reflected light.

### Example 2

Example 2 is a configuration of the second embodiment of the laser beam dimming device. The beam splitter 1 and the beam splitter 2 had a refractive index of 1.449 at a wavelength of 1070 nm, an angle α of a wedge shape of 1°, and a thickness of a position of an optical axis of 7 mm. Then, reflected light and stray light of the beam splitter 1 when condensed light of a laser beam having a wavelength of 1070 nm in which a spot has a dotted shape and an energy intensity distribution is uniform is incident on the beam splitter 2 were simulated using optical design software Optic Studio (manufactured by Zemax Japan Ltd.). Furthermore, the stray light in the simulation is only for the front-surface/back-surface reflection type stray light reflected by the front surface of the beam splitter 2, transmitted through the front surface of the beam splitter 1, reflected by the back surface, and transmitted through the front surface to be emitted, the back-surface/front-surface reflection type stray light transmitted through the front surface of the beam splitter 2, reflected by the back surface, transmitted through the front surface, and reflected by the front surface of the beam splitter 1 to be emitted, and the back-surface/back-surface reflection type stray light transmitted through the front surface of the beam splitter 2, reflected by the back surface, transmitted through the front surface, transmitted through the front surface of the beam splitter 1, reflected by the back surface, and transmitted through the front surface to be emitted, and the laser beam repeatedly reflected inside the beam splitter 2 and the beam splitter 1 and transmitted through the front surface to be emitted is omitted. This is because the position of the image on the imaging plane of the laser beam repeatedly reflected inside the beam splitter 2 or the beam splitter 1 and transmitted through the front surface to be emitted is farther than the stray light to be simulated.

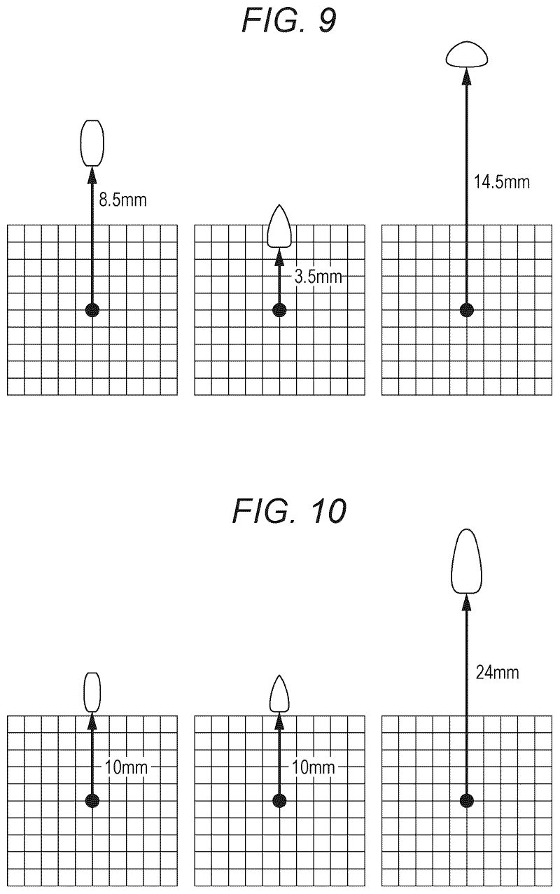

An image of reflected light and stray light on a plane perpendicular to the optical axis on the imaging plane is shown in FIG. 9 with T1=90 mm. FIG. 9 shows, in order from the left, the cases of the front-surface/back-surface reflection type stray light, the back-surface/front-surface reflection type stray light, and the back-surface/back-surface reflection type stray light. The black spot image at each center portion is reflected light. Distorted stray light images are shown at positions separated from the black spot image by T2=8.5 mm, 3.5 mm, and 14.5 mm, respectively. That is, it was confirmed that stray light can be separated from reflected light at a distance of at least T2=3.5 mm in the imaging plane.

### Example 3

Example 3 is a configuration of the second embodiment of the laser beam dimming device. The beam splitter 1 and the beam splitter 2 had a refractive index of 1.449 at a wavelength of 1070 nm, an angle α of a wedge shape of 3°, and a thickness of a position of an optical axis of 7 mm. Then, as in Example 2, the reflected light and the stray light of the beam splitter 1 when the focused light of the laser beam having a wavelength of 1070 nm in which the shape of the spot is dotted and the energy intensity distribution is uniform is incident on the beam splitter 2 were simulated using optical design software Optic Studio (manufactured by Zemax Japan Ltd.).

When T1=40 mm, images of reflected light and stray light on a plane perpendicular to the optical axis on the imaging plane are shown in FIG. 10. FIG. 10 shows, in order from the left, the cases of the front-surface/back-surface reflection type stray light, the back-surface/front-surface reflection type stray light, and the back-surface/back-surface reflection type stray light. The black spot image at each center portion is reflected light. Distorted stray light images are shown at positions separated from the black spot image by T2=10 mm, 10 mm, and 24 mm, respectively. That is, it was confirmed that stray light can be separated from reflected light at a distance of at least T2=10 mm in the imaging plane. Further, in Example 2 in which the wedge-shaped angle α was 1°, T1=90 mm, and the distance T2 of stray light closest to reflected light was 3.5 mm. On the other hand, in Example 3, since the angle α of the wedge shape is 3°, even if T1 was close to 40 mm, the shortest distance T2 of the stray light was 10 mm.

### Example 4

Example 4 is the third embodiment of the laser beam dimming device, and the configuration of FIGS. 4A and 4B is used. The beam splitter 1 and the beam splitter 2′ each had a refractive index of 1.449 at a wavelength of 1070 nm, a wedge-shaped angle α of 0.5°, and a thickness of 7 mm at the position of the optical axis. Then, reflected light and stray light of the beam splitter 1 when condensed light of a laser beam having a wavelength of 1070 nm in which a spot has a dotted shape and an energy intensity distribution is uniform is incident on the beam splitter 2′ were simulated using optical design software Optic Studio (manufactured by Zemax Japan Ltd.). Furthermore, the stray light in the simulation is only for the front-surface/back-surface reflection type stray light reflected by the front surface of the beam splitter 2, transmitted through the front surface of the beam splitter 1, reflected by the back surface, and transmitted through the front surface to be emitted, the back-surface/front-surface reflection type stray light transmitted through the front surface of the beam splitter 2′, reflected by the back surface, transmitted through the front surface, and reflected by the front surface of the beam splitter 1 to be emitted, and the back-surface/back-surface reflection type stray light transmitted through the front surface of the beam splitter 2′, reflected by the back surface, transmitted through the front surface, transmitted through the front surface of the beam splitter 1, reflected by the back surface, and transmitted through the front surface to be emitted, and the laser beam that is repeatedly reflected inside the beam splitter 2′ and the beam splitter 1 and transmitted through the front surface to be emitted is omitted. This is because the position of the image on the imaging plane of the laser beam repeatedly reflected inside the beam splitter 2′ or the beam splitter 1 and transmitted through the front surface to be emitted is farther than the stray light to be simulated.

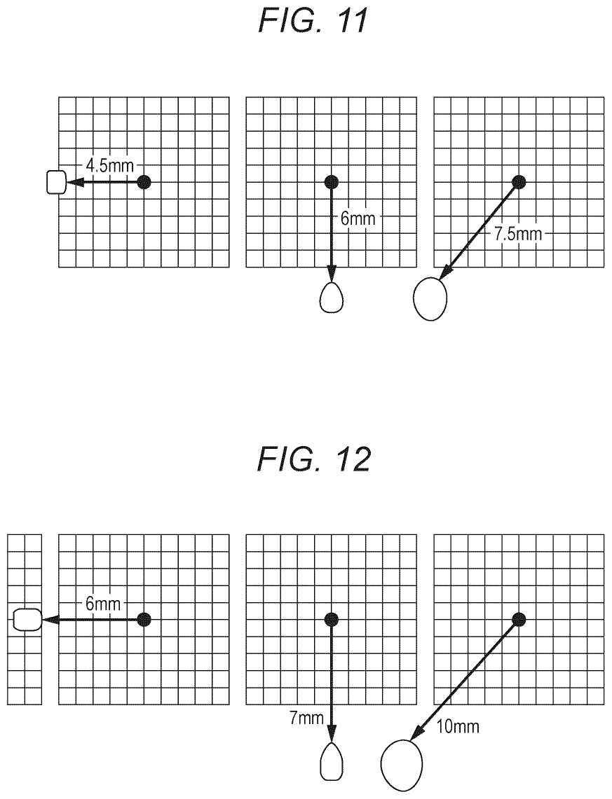

When T1=40 mm, images of reflected light and stray light on a plane perpendicular to the optical axis on the imaging plane are shown in FIG. 11. FIG. 11 shows, in order from the left, the cases of the front-surface/back-surface reflection type stray light, the back-surface/front-surface reflection type stray light, and the back-surface/back-surface reflection type stray light. The black spot image at each center portion is reflected light. Distorted stray light images are shown at positions separated from the black spot image by T2=4.5 mm, 6 mm, and 7.5 mm, respectively. That is, it was confirmed that stray light can be separated from reflected light at a distance of at least T2=4.5 mm in the imaging plane.

### Example 5

In Example 5, the same configuration as in Example 4 was used. Then, as in Example 4, the reflected light and the stray light of the beam splitter 1 when the focused light of the laser beam having a wavelength of 1070 nm in which the shape of the spot is dotted and the energy intensity distribution is uniform is incident on the beam splitter 2′ were simulated using optical design software Optic Studio (manufactured by Zemax Japan Ltd.).

When T1=90 mm, images of reflected light and stray light on a plane perpendicular to the optical axis on the imaging plane are shown in FIG. 12. FIG. 12 shows, in order from the left, the cases of the front-surface/back-surface/front-surface reflection type stray light, and the back-surface/back-surface reflection type stray light. The black spot image at each center portion is reflected light. Distorted stray light images are shown at positions separated from the black spot image by T2=6 mm, 7 mm, and 10 mm, respectively. That is, it was confirmed that stray light can be separated from reflected light at a distance of at least T2=6 mm in the imaging plane.

### Example 6

Example 6 is the third embodiment of the laser beam dimming device, and the configuration of FIGS. 4A and 4B is used. The beam splitter 1 and the beam splitter 2′ each had a refractive index of 1.449 at a wavelength of 1070 nm, a wedge-shaped angle α of 3°, and a thickness of a position of an optical axis of 7 mm. Then, as in Example 4, the reflected light and the stray light of the beam splitter 1 when the focused light of the laser beam having a wavelength of 1070 nm in which the shape of the spot is dotted and the energy intensity distribution is uniform is incident on the beam splitter 2′ were simulated using optical design software Optic Studio (manufactured by Zemax Japan Ltd.).

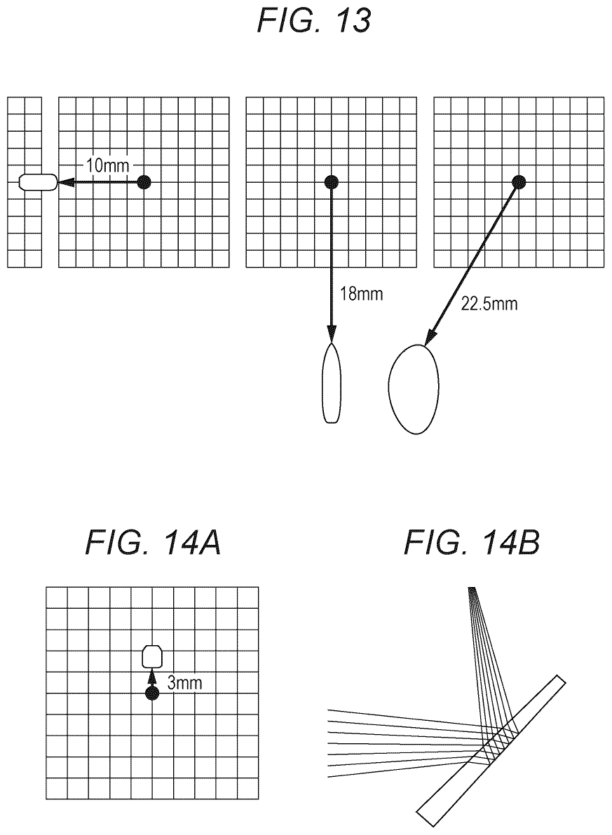

When T1=40 mm, images of reflected light and stray light on a plane perpendicular to the optical axis on the imaging plane are shown in FIG. 13. FIG. 13 shows, in order from the left, the cases of the front-surface/back-surface/front-surface reflection type stray light, and the back-surface/back-surface reflection type stray light. The black spot image at each center portion is reflected light. Distorted stray light images are shown at positions separated from the black spot image by T2=10 mm, 18 mm, and 22.5 mm, respectively. That is, it was confirmed that stray light can be separated from reflected light at a distance of at least T2=10 mm in the imaging plane.

### COMPARATIVE EXAMPLES

### Comparative Example 1

Comparative Example 1 is a comparative example of Example 1. Unlike Example 1, the cross-sectional shape of the beam splitter 1 on the plane determined by the incident light and the reflected light of the beam splitter 1 is a wedge shape in which the incident light side of the beam splitter 1 is thick and the reflected light side of the beam splitter 1 is thin. Other configurations are the same as those of the first embodiment. Then, simulation was performed in the same manner as in Example 1.

When T1=40 mm, an image of reflected light and stray light on a plane perpendicular to the optical axis on the imaging plane is shown in FIG. 14A. The black spot image at the center of FIG. 14A is reflected light. An image of stray light is shown at a position T2=3 mm away from the black spot image. That is, it was found that the stray light separation performance of Comparative Example 1 was inferior to that of Example 1. Furthermore, FIG. 14B shows trajectories of incident light and stray light in the beam splitter 1 in the simulation of Comparative Example 1, and does not show a trajectory of reflected light.

### Comparative Example 2

Comparative Example 2 is a comparative example of Example 3. Unlike Example 3, the cross-sectional shape of the beam splitter 2 on the plane determined by the incident light and the reflected light of the beam splitter 2 is a wedge shape in which the incident light side of the beam splitter 2 is thin and the reflected light side of the beam splitter 2 is thick. Other configurations are the same as those of the third embodiment. Then, simulation was performed in the same manner as in Example 3.

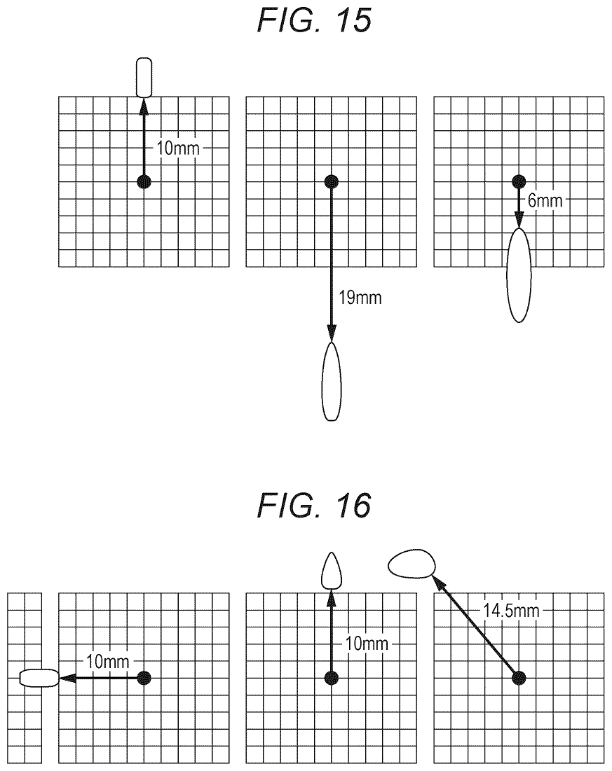

When T1=40 mm, images of reflected light and stray light on a plane perpendicular to the optical axis on the imaging plane are shown in FIG. 15. FIG. 15 shows, in order from the left, the cases of the front-surface/back-surface reflection type stray light, the back-surface/front-surface reflection type stray light, and the back-surface/back-surface reflection type stray light. The black spot image at each center portion is reflected light. Distorted stray light images are shown at positions separated from the black spot image by T2=10 mm, 19 mm, and 6 mm, respectively. The distance T2 of the stray light closest to the reflected light in Example 3 is 10 mm, whereas T2=6 mm in Comparative Example 2. That is, it was found that the stray light separation performance of Comparative Example 2 was inferior to that of Example 3.

### Comparative Example 3

Comparative Example 3 is a comparative example of Example 6. Unlike Example 6, the cross-sectional shape of the beam splitter 2′ in the plane determined by the incident light and the reflected light of the beam splitter 2′ is a wedge shape in which the incident light side of the beam splitter 2′ is thick and the reflected light side of the beam splitter 2′ is thin. Other configurations are the same as those of the sixth embodiment. Then, simulation was performed in the same manner as in Example 6.

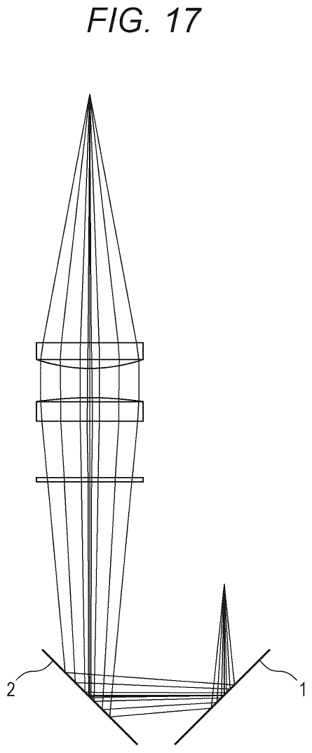

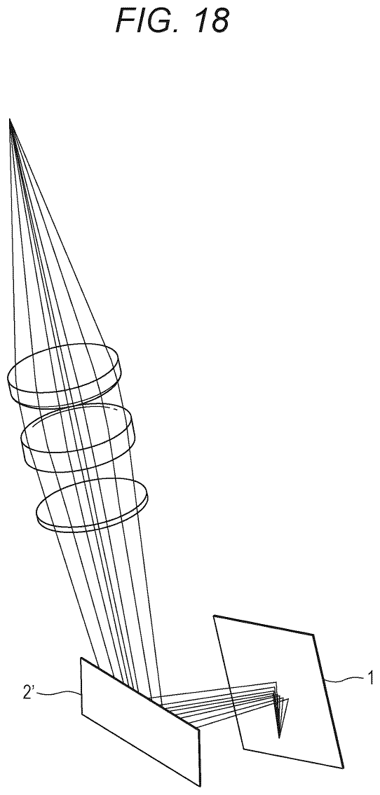

When T1=40 mm, images of reflected light and stray light on a plane perpendicular to the optical axis on the imaging plane are shown in FIG. 16. FIG. 16 shows, in order from the left, the cases of the front-surface/back-surface reflection type stray light, the back-surface/front-surface reflection type stray light, and the back-surface/back-surface reflection type stray light. The black spot image at each center portion is reflected light. Distorted stray light images are shown at positions separated from the black spot image by T2=10 mm, 10 mm, and 14.5 mm, respectively. For the front-surface/back-surface reflection type stray light, T2=10 mm in both Example 6 and Comparative Example 3. However, for the back-surface/front-surface reflection type stray light and the back-surface/back-surface reflection type stray light, the stray light distance T2 in Comparative Example 3 was shorter than that in Example 6. That is, it was found that the stray light separation performance of Comparative Example 3 was inferior to that of Example 6.

The laser beam dimming device according to the present invention can dim the laser beam to a predetermined intensity and separate the observation light and the stray light even when observing observation light having a large numerical aperture. Since the laser beam profiler according to the present invention includes the above-described laser beam dimming device, it is possible to accurately observe and measure the image shape and the energy intensity distribution of the laser beam at the spot. In other words, the laser beam dimming device and laser beam profiler according to the present invention are suitable for use in a laser processing device that irradiates a laser beam to process a workpiece, when the image shape of the laser beam at a spot and the energy intensity distribution of the laser beam are observed and measured using an observation device.

What is claimed is:

1. A laser beam dimming device for dimming a laser beam provided in a laser beam profiler, comprising
a beam splitter 1 in which reflected light is used as observation light,
wherein the beam splitter 1 reflects 10% or less of incident light,
wherein the beam splitter 1 is disposed such that an incident angle of incident light at a position of an optical axis is 45° with an X axis as a rotation axis when arbitrary orthogonal coordinate axes whose origin on a plane perpendicular to the optical axis is on the optical axis are an X axis and a Y axis, and
wherein a cross-sectional shape of the beam splitter 1 on a plane determined by the incident light and the reflected light of the beam splitter 1 is a wedge shape in which an incident light side of the beam splitter 1 is thin and a reflected light side of the beam splitter 1 is thick.

2. The laser beam dimming device according to claim 1, wherein an angle of the wedge shape of the beam splitter 1 is 0.5° or more.

3. The laser beam dimming device according to claim 1, further comprising
a beam splitter 2 that is disposed such that the incident angle of incident light at the position of the optical axis is parallel to the X axis and is 45° with an X ‘axis passing through the optical axis as a rotation axis,
wherein the beam splitter 2 reflects 10% or less of incident light,
wherein the beam splitter 2 is disposed such that reflected light of the beam splitter 2 is incident on the beam splitter 1,
wherein a direction of a reflection surface of the beam splitter 2 is a direction in which a plane including the reflection surface of the beam splitter 1 and a plane including the reflection surface of the beam splitter 2 are orthogonal to each other, and
wherein a cross-sectional shape of the beam splitter 2 on a plane determined by the incident light and the reflected light of the beam splitter 2 is a wedge shape in which an incident light side of the beam splitter 2 is thick and a reflected light side of the beam splitter 2 is thin.

4. The laser beam dimming device according to claim 3, wherein the angle of the wedge shape of the beam splitter 2 is 0.5° or more.

5. The laser beam dimming device according to claim 1, further comprising
a beam splitter 2′ that is disposed such that the incident angle of incident light at the position of the optical axis is parallel to the Y axis and is 45° with a Y′ axis passing through the optical axis as a rotation axis,
wherein the beam splitter 2′ reflects 10% or less of incident light,
wherein the beam splitter 2′ is disposed such that reflected light of the beam splitter 2′ is incident on the beam splitter 1, and
wherein a cross-sectional shape of the beam splitter 2′ on a plane determined by the incident light and the reflected light of the beam splitter 2′ is a wedge shape in which an incident light side of the beam splitter 2′ is thin and a reflected light side of the beam splitter 2′ is thick.

6. The laser beam dimming device according to claim 5, wherein an angle of the wedge shape of the beam splitter 2′ is 0.5° or more.

7. A laser beam profiler comprising:
the laser beam dimming device according to claim 1; and
an observation device that observes observation light dimmed by the laser beam dimming device.
